(19) United States
(12) Patent Application Publication
(10) Pub. No.: US 2026/0295467 A1
(43) Pub. Date: Oct. 1, 2026

(54) COALESCING PLATE STACKING SUPPORT ASSEMBLY

(71) Applicant: PARK ENVIRONMENTAL EQUIPMENT, LLC, Houston, TX (US)

(72) Inventors: Christopher Nolan EBERLY, Chappell Hill, TX (US); Andreas H. VU, Houston, TX (US); Kate T. VU, Houston, TX (US)

(21) Appl. No.: 19/304,283

(22) Filed: Aug. 19, 2025

Related U.S. Application Data
(63) Continuation-in-part of application No. 19/089,732, filed on Mar. 25, 2025.

(51) Int. Cl. B01D 17/04; B01D 17/02

(52) U.S. Cl. CPC B01D 17/045; B01D 17/0214

(57) ABSTRACT

A coalescing system for separating immiscible components of different densities mixed in a fluid has a vessel with a fluid inlet and a lighter component outlet and a heavier component outlet, a coalescing stack formed of at least a first coalescing plate and a second coalescing plate arranged in spaced relation to each other, and a plurality of pegs affixed to each of the first coalescing plate and the second coalescing plate. The plurality of pegs of the first coalescing plate engaging the plurality of pegs of the second coalescing plate in a first position so as to define a first distance between the first coalescing plate and the second coalescing plate. The first coalescing plate being movable with respect to the second coalescing plate to a second position such that an engagement between the plurality of pegs of the first coalescing plate and the plurality of pegs of the second coalescing plate defines a second distance between the coalescing plates. The first distance is different than the second distance.

### CROSS-REFERENCE TO RELATED APPLICATIONS

The present application is a continuation-in-part of U.S. patent application Ser. No. 19/089732, filed on Mar. 25, 2025, presently pending.

### FIELD OF THE INVENTION

The present invention relates to the field of separation of oil, solid particles and water for environmental and industrial purposes. More particularly, the present invention relates to coalescing stacks used for the separation of oil and solid particles from water. In particular, the present invention relates to connectors for forming a variable distance between adjacent coalescing plates of the coalescing plate stack.

### BACKGROUND OF THE INVENTION

There is a need for economical oil/water separators to process rainwater and industrial wastewater so as to remove hydrocarbons and vegetable oils. These oil/water separators can also remove incidentally included oil from machine-tool coolant. Coalescing media is often used as part of the oil/water separators. Coalescing media consists of stacked plates composed generally of plastic and other materials. The stacked plates may be flat, corrugated or angled in multiple corrugated plates or in a coalescing plate stack. Coalescing media can be stacked either horizontally or at an angle from horizontal. The coalescing media as part of the separator which actually capture small oil droplets in order to remove them from flowing downstream, and directs the captured oil to the upper surface of the water. Typically, the oil is captured on the underside of the plates according to Stokes' law by the oil droplets rising up to meet the underside of the plates and forming a film thereon and eventually migrating up to the underside of the plates to the oil ports in the peaks of the plates.

An example of a coalescing plate packing system of the prior art was shown in U.S. Pat. No. 5,068,035, issued on Nov. 26, 1991 to K. S. Mohr. This coalescing plate packing system is illustrated, in particular, in association with the prior art of FIGS. 1 and 2. FIGS. 1 and 2 show a system for separating immiscible heavier and lighter components of a fluid mixture. The system includes a vessel 10 having a bottom 12, and an open top 14. It also includes end walls 16 and 18 that are in parallel planar relationship to each other. There also parallel planar side walls 20 and 22 (see FIG. 2). The vessel 10 includes a mixture inlet 24, a lighter component outlet 26 and a heavier component outlet 28. A weir 30 provides a means of skimming off lighter components, such as oil.

The system 10 has the lighter oil component accumulated on the top of the mixture and flows over the top edge 30A of weir 30 into the lighter component outlet 26. In contrast, water 34 accumulates in the lower portion of the vessel. The interface between the lighter component, oil and the heavier component (water) is indicated at 36. A means is provided for maintaining interface 36 at a preselected level below the top edge 30A of weir 30. A float 38 senses the level of interface 36 and, by means of a control system, water 38 is drained from the vessel through a pneumatic line 44 through a control valve 46. This maintains the interface level 36.

In order to enhance the separation of lighter components from heavier components of a mixture, a coalescing pack 48 is provided. The coalescing pack is assembled as a unit outside of the vessel 10 and placed as a unit into the vessel. The coalescing pack 48 includes a plurality of coalescing plates 50, a pair of bottom supports 52 and 58 that stand upright in spaced parallel planes, and a pair of top supports 56 and 58 that are placed in vertical planes above the bottom supports 52 and 54, respectively.

Each of the coalescing plates 50 has orthogonally structured corrugations, running both laterally and longitudinally along a single plane of the plate. This arrangement provides the plates with crests and valleys. Opening 60 are provided in the valleys and presses. Semi-circular opening 62 are provided in the edges. The semi-circular opening 62 opens in the crest of the lateral corrugations when plates are joined contiguous to each other. The opening 60 formed in the lateral valleys of the corrugated plates 50 permit the heavier liquid component (i.e. water) and particulate matter to migrate through the plates in vertical downward migration. Opening 60 in the crests permit the lighter component (i.e. oil) to migrate vertically upwardly.

FIG. 2 shows details, in an elevation view, of a bottom support 52 and a top support 56. The supports are preferably molded of a polymeric material. The supports 52 and 56 are used in an upright arrangement and spaced apart in generally parallel planes. The bottom support 52 has a bottom edge 64 that is preferably flat or at least of a configuration to substantially conform to the bottom 12 of the vessel 10.

Bottom support 52 further has an upper edge 66 that corresponds to the lateral corrugations of the coalescing plates 50. The perimeter of bottom support 50 is completed by opposite parallel sides 68 and 70. The spacing between the sides 68 and 70 is slightly less than the spacing between the vessel side walls 20 and 22. Bottom support 52 is preferably of a molded polymeric material and has integral reinforcing rib 72 that can be arranged in a variety of different configurations to add strength to the structure. The bottom support 52 is closed such that fluid cannot flow through it since there are no openings between the ribs.

The top support 56 is preferably molded of a polymeric material and has a top edge 74 that is generally flat. A bottom edge is undulating to conform to the lateral corrugation of coalescing plates 50. Top support 56 further has opposed sides 78 and 80 that are parallel to each other and spaced apart by a width that is slightly less than the width of the vessel side walls 20 and 22.

Bottom support 52 has a small diameter vertical passageway 82 therein that is centrally located between sides 68 and 70. The top support 56 has a vertical passageway 84 equally spaced between sides 78 and 80. The passageways 82 and 84 are in vertical alignment with each other. Openings 82 and 84 receive an elongated rod 86 that has a threaded portion adjacent each other. Rod 86 is used for each of the pair of top and bottom supports. Nuts 88 and 90 are used to secure the stack of coalescing plates 50 between the opposing pairs of bottom supports 52 and 54 and the top supports 56 and 58 in a unitary package. Thus, the coalescing package 48 can be assembled and installed into the vessel. Each of the top supports 56 and 58 can have an integral lifting eye 92 and 94.

The top supports 56 and 58 each has semi-circular recesses at the opposed sides 78 and 80. Recesses 96 coincide in alignment with the semi-circular opening 62 of the coalescing plates. The recess 96 in the top and bottom supports and the semi-circular opening 62 in the coalescing plates receive tubes 98. Tubes 98 may be inserted into the aligned semi-circular openings in the top and bottom coalescing supports after the pack 48 is inserted into the vessel 10.

With reference to FIGS. 1-3, the bottom support 52 has a small diameter vertical passageway 82 therein that is centrally located between the sides 68 and 70. Also, the top support 56 has a vertical passageway 84 equally spaced between sides 78 and 80. The passageways 82 and 84 are in vertical alignment with each other. Openings 82 and 84 receive an elongated rod 86 that preferably has a threaded portion adjacent each end. The rod 86 is used for each of the top support and the bottom support. The use of nuts 88 and 90 serve to secure the stack of the coalescing plates 50 between opposing pairs of bottom supports 52 and 54 and top supports 56 and 58 in a unitary package. Thus, the coalescing package 48 may be assembled and installed directly into vessel 10. In order to assist in the installation or removal, the top supports 56 and 58 are each provided with integral lifting eyes 92 and 94 that are spaced equally apart from the vertical opening 84 in each of the top supports.

It can also be seen in FIGS. 1-3, the top supports 56 and 58 each have semi-circular recesses 96 at their opposed sides 78 and 80. Recesses 96 coincide in alignment with the semi-circular opening 62 of the coalescing plates. The recesses 96 and the top and bottom supports and semi-circular opening 62 and the coalescing plates receive tubes 98. Tubes 98 may be inserted into the aligned semi-circular openings in the top and bottom coalescing supports after the package 48 is inserted into the vessel. 10. These tubes 98 serve to reduce the flow of mixture past the top and bottom supports to thereby concentrate the flow of fluid mixture through the spaces between stack coalescing plates.

In the past, a variety of patents and publications have issued with respect to such coalescing plate packs and the supports associated therewith. An early patent is that of U.S. Pat. No. 3,847,813, issued on Nov. 12, 1974 to J. L. Castelli. This patent describes a coalescing plate for a fluid mixture plate separator. These coalescing plates are formed with integral spacers so as to permit the plates to be joined in the stacks. The stacks can be made with the plates vertically aligned or offset laterally for inclined stacks.

U.S. Pat. No. 4,802,978, issued on Feb. 7, 1989 to Schmit et al., teaches an oil/water separator that having a vertical, cylindrical tank with a plurality of corrugated, oleophilic plates. A corrugated diffusion baffle is located adjacent an oil/water mixture inlet to remove the larger particulate material from the mixture and cause coalescing of the larger oil droplets. The flow of the oil/water mixture proceeds generally in a vertical direction and passes between the corrugated plates to cause further coalescing of the oil droplets. A separate oil channel directs the coalesced oil to an upper portion of the tank. The clarified water then passes downwardly to a clean water outlet.

U.S. Pat. No. 5,762,810, issued on Jun. 9, 1988 to Pelton et al. discloses a coalescing oil/water separator for removing free and dispersed oil from a wastewater stream with increased separation efficiency so as to produce a substantially oil-free effluent. The coalescing oil/water separator is self-contained in a tank shell and includes an improved oil coalescing medium for separating oil out of the wastewater and a series of baffles and weirs to direct flow, to skim the separated oil, and to control the liquid level in the separator. The oil coalescing medium includes a plurality of molded, stackable perforated sheets or plates having an oleophilic surface and an increased coalescing surface area for inducing impingement of oil droplets on the medium surface. Each stackable sheet includes a plurality of openings and recesses which are aligned and positioned to form numerous closely-spaced vertical and horizontal communicating passages for maximizing the flow rate of wastewater while simultaneously maximizing the coalescing surface area of the medium.

U.S. Pat. No. 6,730,236, issued on May 4, 2004 to G. E. Kouba, provides a method of separating liquids in a separation system having a flow coalescing apparatus. The flow conditioning apparatus includes an inlet, an outlet, and a swirl chamber extending along a swirl axis. The inlet and outlet cooperate with the swirl chamber to create a swirling of a fluid mixture passing through the swirl chamber to ideally induce coalescence of liquid droplets. The flow of the fluid mixture through the apparatus encounters a minimum of fluid shear and associated droplet dispersion.

U.S. Pat. No. 7,416,657, issued on Aug. 26, 2008 to R. J. Kretchmar, describes an oil/water coalescing separator that is a coalescing chamber containing an oil-coalescing media. The separator is substantially transparent so that the thickness of the band of coalesced oil can be visually discerned at a glance. The separator has a magnet base so the separator can be hung on a machine and off the floor. The separator is also removable from the magnet base.

U.S. Pat. No. 8,985,343, issued on Mar. 24, 2005 to K. S. Mohr, teaches a separator plate used for separating immiscible liquids and solids from a liquid mixture. The oil/water separator plate is composed of bi-directional corrugations extending in both lateral and longitudinal directions, thereby forming a plurality of peaks and valleys. A ramp extends from each peak to the neighboring valleys. An elongated oil port is formed in the peak for passing immiscible liquids that disengage from the liquid mixture. Fences are included along the lower surface of the plate to guide the rising immiscible liquid. The separator plate is configured for stacking by selectively engaging a pin with one of a number of sockets in another plate. The pin and sockets permit varied vertical spacing and alignment in both lateral directions and longitudinal directions.

U.S. Pat. No. 9,289,700, issued Mar. 22, 2016 to Andreussi, provides a coalescence separator for a mixture of immiscible phases with different specific densities. The apparatus includes a tubular body close to the opposite ends and an inlet mouth. There is an outlet mouth of a fluid phase which is defined close to the end of the tubular body at an upper location. Another outlet mouth of the fluid phase is defined close to the end of the tubular body at a lower height. A set of coalescence plates are housed inside the tubular body. Each of the coalescence plates has a flow plate which is tilted at an angle with respect to a plane orthogonal to the longitudinal axis of the tubular body and which has a lower edge facing an end of the tubular body at a lower height and in fluid communication with a distribution channel of the mixture to be separated.

U.S. Pat. No. 11,691,093, issued on Jul. 4, 2023 to Oshinowo et al., provides a coalescing plate having a phyllotaxis-derived pattern. This coalescer plate separates a mixture of immiscible fluids. The coalescer plate includes a pattern of wetting and non-wetting ring regions.

Canadian Patent No. 2 389 065, issued on Jan. 24, 2003 to G. G. Aymong, provides a coalescer apparatus in an oil/water separator. The coalescer includes a frame that supports coalescing plates that are inclined upwardly from the bottom of the frame member. The coalescing plates run parallel to each other that are spaced equally apart. The coalescing plates have a bottom surface that is corrugated and a top surface that is flat without corrugations. Water containing oil and solids is passed through the coalescing apparatus and separation of the oil and solids from the water occurs. The solids fall to the top flat surface of the inclined coalescing plates. The inclined flat surface causes the solids to slide down the plate and out of the coalescer.

Canadian U.S. Pat. No. 1,149,756, issued on Jul. 12, 1983 to P. B. Smith, also discloses a coalescer plate for oily water separation. The separator has a plurality of parallel corrugated plates between which the oil/water mixture is constrained to flow. The adjacent plates are separated by spacing and are smoothly shaped to provide substantially laminar flow therealong in a direction generally transverse to the corrugations. A spacing is positioned between a pair of plates at a crest or at a trough in the corrugations.

Korean Patent No. 100230914, issued on Nov. 15, 1999, teaches a separator for water and oil having a dam plate having a plurality of through holes for passing water and oil therethrough. Front and rear flow rate distribution plates have slits elongated in the longitudinal direction at predetermined intervals to distribute the flow rate of the mixed water passing through the through hole of the dam plate. A continuous air ridge and a valet, along with an air chamber, is formed in each ridge so as to define a plurality of water layers. An oil/water separation layer causes the oil floating in the water layers of the air chambers to float to the uppermost surface of the collection tank.

Traditional coalescing plates are limited by fixed spacing configurations. This fixed spacing configuration restricts the ability for such coalescing plates to adapt to varying flow rates, contamination loads and operational movements. Any attempt in the prior art so as to vary the spacing between the coalescing plates requires additional components and complex installation. As such, a need has developed so as to provide variable vertical spacing between the coalescing plates.

It is an object of the present invention to provide coalescing plate system that allows the coalescing plates to stack to the same length regardless of a one-quarter inch or one-half inch stacking height between the plates.

It is another object of the present invention to provide a coalescing system which uses a lower support and an upper support having identical configurations.

It is another object of the present invention to provide a coalescing system that allows the use of supports at a midsection of the coalescing plate stack in order to strengthen the coalescing plate stack in high-flow situations.

It is another object of the present invention to provide a coalescing system which allows the coalescing stack to be supported by up to ten supports in order to provide added strength and stability.

It is another object of the present invention to provide a coalescing system which minimizes the injection molding requirements for the formation of the stacking assembly.

It is another object of the present invention to provide a coalescing system which allows an adjustment of the distance between the coalescing plate in a simple, fast and convenient manner.

It is another object of the present invention to provide a coalescing system that allows a lifting handle to lift the coalescing plate assembly with a single-point attachment.

These and other objects and advantages of the present invention will become apparent from a reading of the attached specification and appended claims.

### SUMMARY OF THE INVENTION

The present invention is a coalescing system for separating inadmissible components of different densities mixed in a fluid. The coalescing system includes a vessel having a fluid inlet and a lighter component outlet and a heavier component outlet, a coalescing stack formed of at least a first coalescing plate and a second coalescing plate arranged in spaced relation to each other, and a plurality of pegs affixed to each of the first coalescing plate and the second coalescing plate. The first coalescing plate and the second coalescing plate have corrugations defining crests and valleys thereon. The plurality of pegs of the first coalescing plate engages the plurality of pegs of the second coalescing plate in a first position so as to define a first distance between the first coalescing plate and the second coalescing plate. The first coalescing plate is movable with respect to the second coalescing plate to a second position such that an engagement between the plurality of pegs of the first coalescing plate and the plurality of pegs of the second coalescing plate defines a second distance between the first coalescing plate and the second coalescing plate.

The plurality of pegs are positioned in at least some of the valleys of the first coalescing plate. Similarly, other pegs of the plurality of pegs are positioned in at least some of the valleys of the second coalescing plate.

Each peg of the plurality of pegs includes a body having an outer surface and a pair of internal channels formed interior of the body. The outer surface of the peg of the second coalescing plate engages one of the pair of internal channels of the peg of the first coalescing plate in the first position. The outer surface of the peg of the second coalescing plate engages another of the pair of channels of the peg of the first coalescing plate in the second position.

The body has a projection extending outwardly therefrom. This projection has at least one external shoulder formed thereon. One of the pair of channels of the body has at least one internal shoulder form therein. The external surface of the projection of the body of the plurality of pegs on the second coalescing plate is received in more one of the pair of channels of the plurality of pegs on the first coalescing plate so as to abut the internal shoulder of the internal channel when the first coalescing plate and the second coalescing plate are in the first position. In this embodiment the present invention, the distance between the first coalescing plate and the second coalescing plate (in this configuration) is one-quarter inch.

The projection of the body has a tip portion. This tip portion of the body of the peg on the second coalescing plate is received in another channel of the body of the plurality of pegs on the first coalescing plate so as to separate the first coalescing plate and the second coalescing plate by the second distance. In this embodiment of the present invention, the second distance will be one-half inch. The first coalescing plate will be rotated by approximately 180° with respect to the second coalescing plate so as to move from the first position to the second position.

Each of the plurality pegs is injection molded of the polymeric material. The pair of internal channels of the body of each peg of the plurality of pegs is in side-by-side parallel axial relationship. The body of each peg of the plurality of pegs has a curved outer surface conforming to a curvature of the corrugation of the coalescing plate of the coalescing stack. The coalescing plate has overlapping holes formed therein. The overlapping holes receive the body of the peg of the plurality of pegs.

The present invention is also a peg article for joining coalescing plates of the coalescing stack. This peg article includes a body having a pair of channels formed therein and a projection extending outwardly of the body. The projection has at least one external shoulder formed thereon and a tip portion. The tip portion is distal of the body. One of the pair of channels has an internal shoulder formed therein.

The tip portion of the projection has a diameter less than an inner diameter of one of the pair of channels of the body. One of the pair of channels opens at the bottom of the body so as to define an opening. This opening has a diameter greater than a diameter of the external shoulder of the projection. The internal shoulder has a diameter less than a diameter of the external diameter of the projection. The pair of channels of the body are in axial parallel relation to each other. Each of the coalescing plates of the coalescing stack has a corrugated surface. The body has a curved outer surface conforming to the corrugated surface.

The plate configuration of the present invention is optimized for different stacking configurations. This allows the coalescing plates to stack to the same length regardless of a one-quarter inch or a one-half inch stacking height between the plates. The present invention utilizes identical lower supports and top supports. As such, the injection molding of the top support and the bottom support can be made with the same injection mold. The present invention allows for supports to be used in the midsection of the coalescing stack in order to strengthen the coalescing stack in high-flow situations. Under those circumstances where the coalescing stack is over five feet tall, the coalescing stack can be supported by up to ten supports for added strength and stability.

The peg used in the present invention as soft rounded corners and edges so as to better conform to the structure of the coalescing plates. The present invention requires only four gates for injection molding as opposed to eight gates of the previous embodiment (shown in U.S. Pat. No. 8,985,343 described herein). The present invention requires far fewer push pins in order to push the part from the mold. The present invention allows only ten pegs to be used as opposed to the eighteen pegs of U.S. Pat. No. 8,985,343. Also, in the present invention, a lifting handle is designed for a single point attachment. This allows a crane to move the coalescing assembly out of the vessel.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a side cross-sectional view showing the coalescing system in accordance with the prior art.

FIG. 2 is an end cross-sectional view of the coalescing system in accordance with the prior art.

FIG. 3 is a plan view showing a coalescing plate used in the coalescing system of the prior art.

FIG. 4 is a magnified cross-sectional view of the peg as used in the coalescing system of the present invention.

FIG. 5 is a partial cross-sectional view showing the engagement between adjacent pegs of the coalescing system of the present invention with the coalescing plates as being spaced by a distance.

FIG. 6 is a partial cross-sectional view of the coalescing plates of the coalescing stack in which the adjacent pegs are joined so as to have the coalescing plate separated by another distance.

FIG. 7 is an upper perspective view showing the coalescing plate assembly and a top support in accordance with the present invention.

FIG. 8 is a plan top view showing the coalescing plate assembly of the present invention.

FIG. 9 is an upper perspective view of a crossbar as used on the top of the coalescing stack assembly of the present invention.

### DETAILED DESCRIPTION OF THE INVENTION

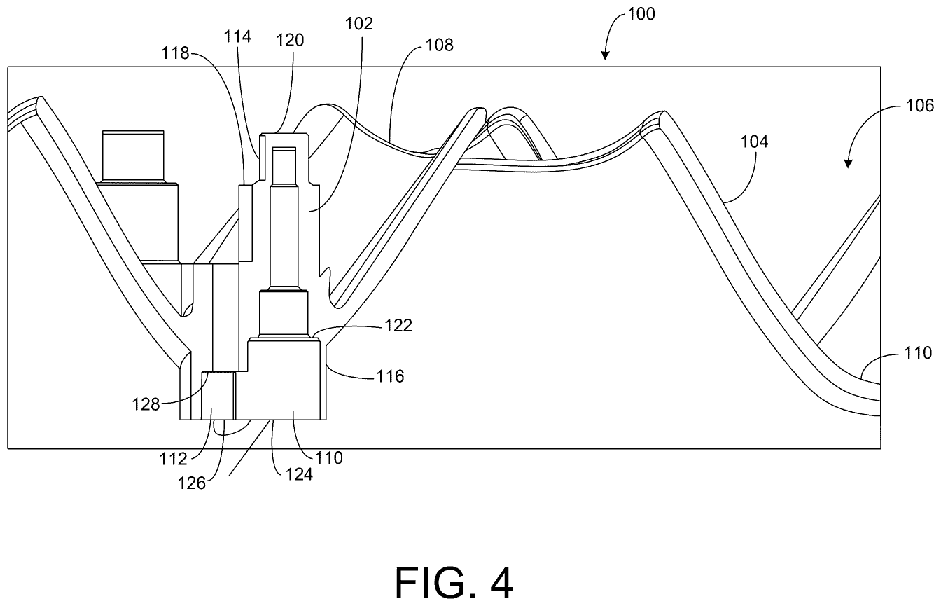

Referring to FIG. 4, there is shown the assembly 100 of the peg 102 used with the coalescing plate 104 of a coalescing stack 106 in accordance with the present invention. As can be seen, the coalescing plate 104 has a crest 108 and a valley 110 formed thereon. The peg 102 is received in the valley of the coalescing plate 104. The peg 102 is adapted for joining adjacent coalescing plates 104 of a coalescing stack. As can be seen in FIG. 4, the peg 102 has a pair of channels 110 and 112 formed therein. A projection 114 extends outwardly of a body 116. The projection 114 has an external shoulder 118 formed thereon and a tip portion 120. The tip portion 120 is distal of the body 116. The channel 110 has an internal shoulder 122 formed therein.

As can be seen, the tip portion 120 has a diameter less than an inner diameter of the channels 110 and 112 of the body 116. Channel 110 has an opening 124 at the bottom of the body 116. Similarly, the channel 112 has an opening 126 at the bottom of the body 116. The openings 124 and 126 are adapted so as to receive the projection 114 of the peg 102. The opening 124 has a diameter greater than the diameter of the external shoulder 118 of the projection 114. The internal shoulder 122 has a diameter less than a diameter of the external shoulder 118 of the projection 114.

It can be seen that the pair of channels 110 and 120 are in axially parallel relationship to each other. The body 116 of the peg 102 has a curved outer surface that conforms to the corrugated surface of the coalescing plate 104.

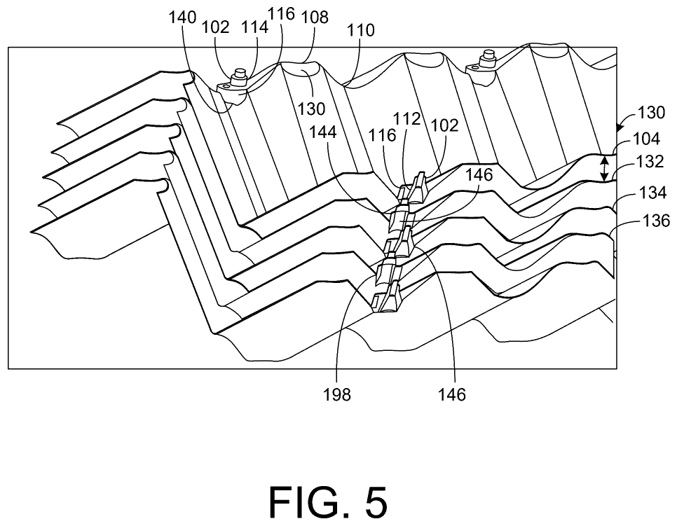

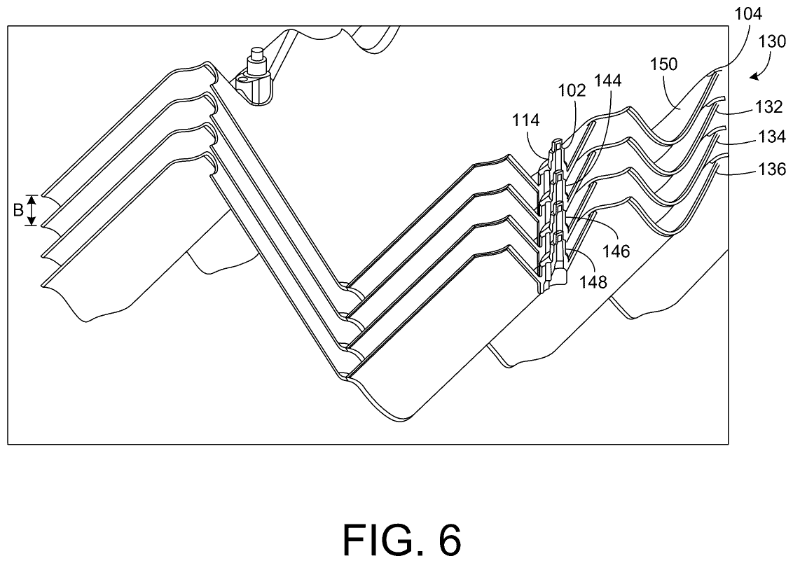

As will be described hereinafter, the coalescing plate 104 is adaptable for use with an adjacent coalescing plate. The plurality of pegs 102 allow for the distance between the adjacent coalescing plates to be adjusted between a one-quarter inch distance and a one-half inch distance. This is easily accomplished by rotating one of the coalescing plates 180° with respect to the adjacent coalescing plate. As such, the respective pegs 102 of the respective coalescing plates will be aligned with one of the channels 110 and 112. So as to establish a one-quarter inch spacing between the adjacent coalescing plates, the projection 114 of the peg 102 will enter the opening 124 of the adjacent peg such that the external shoulder 118 will reside against the internal shoulder 122 of the adjacent plate. This will fix a one-quarter inch distance between the respective coalescing plates. When the coalescing plates are rotated 180° with respect to each other, the tip portion 120 of the peg 102 will enter the opening 126 of the other channel 112. In this configuration, the external shoulder 118 will reside against the bottom of the body 116. The tip portion 120 will be adjacent to an internal shoulder 128 of the channel 112. This will establish a one-half inch distance spacing between the adjacent coalescing plates. FIGS. 5 and 6 will show this configuration between the adjacent pegs.

FIG. 5 shows a coalescing plate stack 130 having coalescing plates 104, 132, 134 and 136 arranged in a stacked configuration. The spacing “A” between the adjacent plates 104 and 132 will be one-half inch. A similar distance or spacing will occur between the coalescing plates 132 and 134 and also between coalescing plates 134 and 136. It is to be noted that there is a very large number of coalescing plates 104 within the coalescing stack. FIG. 5 merely shows a portion of the stack.

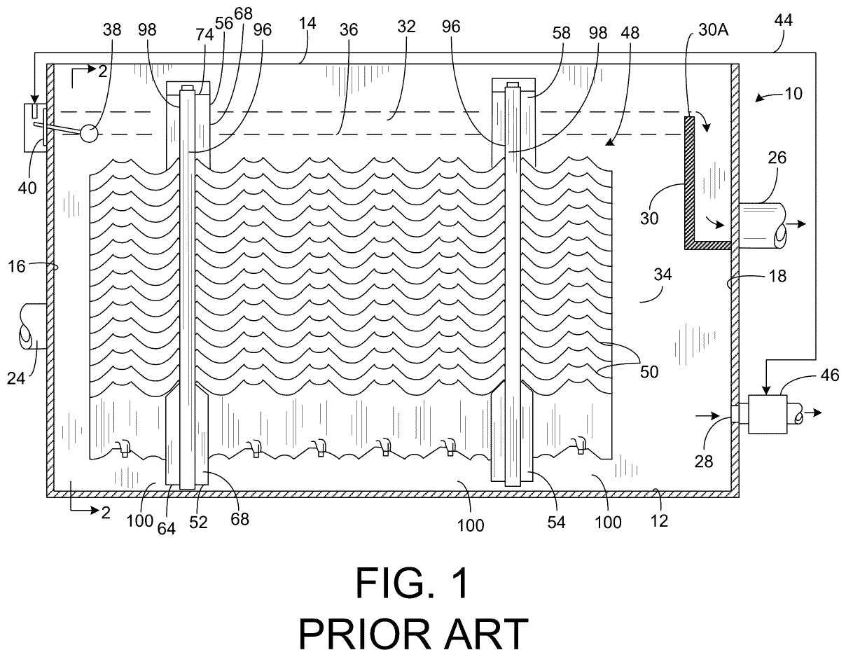

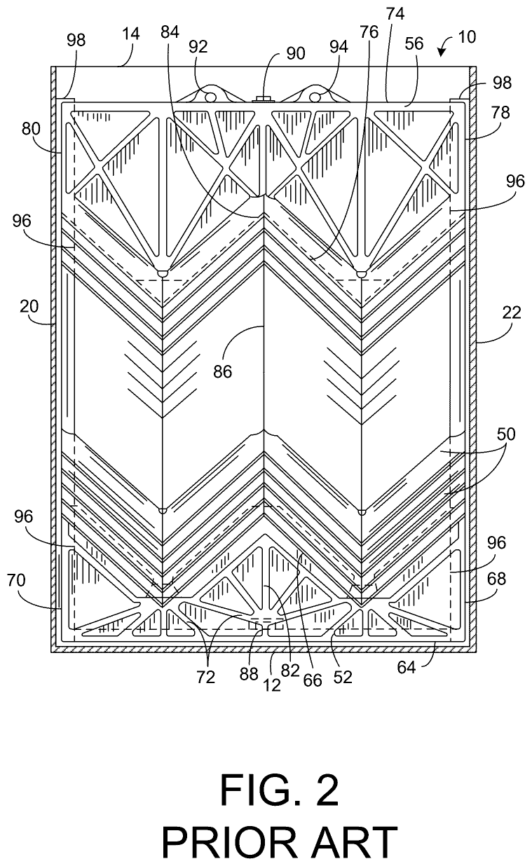

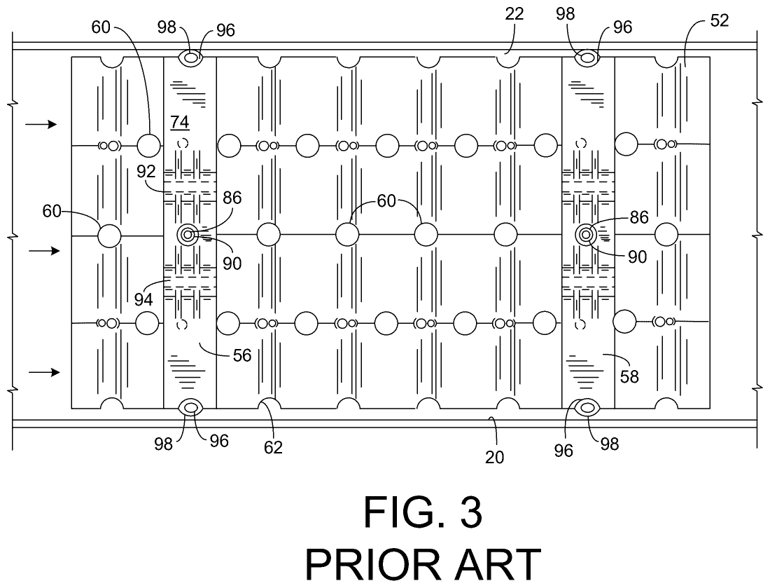

Initially, it can be seen that the peg 102 is received within the valley 110 of the coalescing plate 104. The crest 108 will have an opening 138 formed therein. Opening 138 facilitates the ability for the components of the immiscible fluid to flow therethrough and through the coalescing plate assembly (in the manner described herein previously in associations FIGS. 1-3). The peg 102 has a body 116 with an external surface that is shown as being curved so as to conform with the curvature of the corrugation of the coalescing plate 104. In particular, the body 116 is received within overlapping holes 140 formed at the valley 110 of the coalescing plate 104. It can be seen that the projection 114 extends outwardly of the body 116 so as to be joined with the peg 102 of the adjacent coalescing plate.

FIG. 5 illustrates, in particular, how the pegs can be joined together so as to set the one-half inch distance between the respective coalescing plates. In FIG. 5, as stated previously, the peg 102 is illustrated as extending outwardly of the coalescing plate 104. The body 116 has a pair of channels 110 and 112 formed therein. The coalescing plate 132 is illustrated as having a peg 144. Peg 144 includes a projection that is illustrated as being received within the channel 112 of the body 116 of peg 102. As such, the bottom of the peg 102 will reside against the shoulder 118 of the adjacent peg 144. A similar arrangement of pegs 146 and 148 is illustrated in FIG. 5. As can be seen, the projection of the peg 144 is on an opposite side from the projection 114 of the peg 102. The projection of the peg 146 is on an opposite side from the projection of the peg 144. Similarly, the projection of the peg 148 is on an opposite side from the projection of the peg 146. As such, the various coalescing plates 104, 132, 134, and 136 can be stacked so as to achieve the proper spacing “A” of one-half inch.

FIG. 6 shows an alternate view of the spacing of the coalescing stack assembly 130. Coalescing stack assembly 130, as shown in FIG. 6, includes coalescing plates 104, 132, 134, and 136. The adjacent plates are rotated 180° with respect to each other such that the respective pegs are aligned with each other. As can be seen, the projection 114 of the peg 102 extends outwardly of the top surface 150 of the coalescing plate 104. The adjacent pegs 144, 146 and 148 are aligned with each other. It can be seen that the projection 114 of the peg 144 is received within the channel 110 of the peg 102. The tip portion 120 of the peg 114 enters the opening 124 at the bottom of the body of the peg 102 so that an external shoulder 118 (as shown in FIG. 4) resides against the internal shoulder 122) of the channel 110. This will establish a spacing “B” between the adjacent coalescing plates 104, 132, 134 and 136. The spacing “B”, in the preferred embodiment of the present invention, is one-quarter inch.

As can be seen in FIGS. 4-6, the present invention is easily adaptable to achieve varying spacing between the adjacent coalescing plates. This is easily achieved by the rotation of adjacent plates with respect to each other and then joining the channel of the respective pegs with the associated projection of the body of an adjacent peg. As such, if the desired spacing of one-quarter inches is desired between the coalescing plates for the separating of immiscible components of different densities mixed in a fluid, the user or manufacturer can easily set this distance with minimal effort. The pegs used in the present invention have soft rounded corners and edges to better conform to the structure of the coalescing plates. As such, the present invention requires only four gates for injection molding as opposed to the eight or more gates of the prior art of U.S. Pat. No. 8,985,343. The present invention requires far fewer push pins than the prior art in order to push the part from the mold. The present invention minimizes the number of pegs that are required for the joining of the coalescing plates.

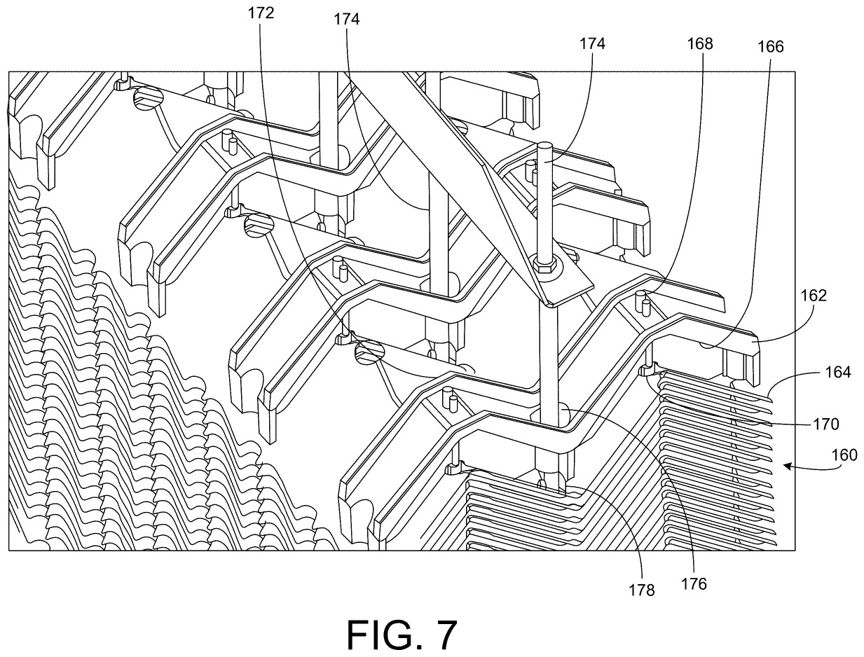

FIG. 7 illustrates the coalescing plate stack assembly 160. The coalescing plate stack assembly has a configuration similar to that shown herein in FIGS. 5 and 6. In particular, there is a top support 162 that is positioned above the uppermost plate 164. The top support 162 has an inner surface 166 that undulates so as to conform with the configuration of the uppermost coalescing plate 164. A pin assembly 168 is joined to the upper support 162 and can be joined into the open end of the peg 170. The pins 168 are located at the crests 172 of the respective top supports 162. The joining of the pins 168 and 172 to the respective coalescing plates 164 maintains the alignment of the coalescing plates 164 with respect to the top support 162.

FIG. 7 shows that there is a rod 174 that extends through an opening 176 of the respective top supports 162. Rod 174 will also extend through the respective openings 178 of each of the coalescing plates 164 of the coalescing stack 160. As such, the coalescing stack assembly 160 is suitably configured for installation into the vessel. As stated herein previously in association with FIGS. 1-3, the vessel will have a fluid inlet, a lighter component outlet and a heavier component outlet. A cross member 180 is joined to the respective rods 174.

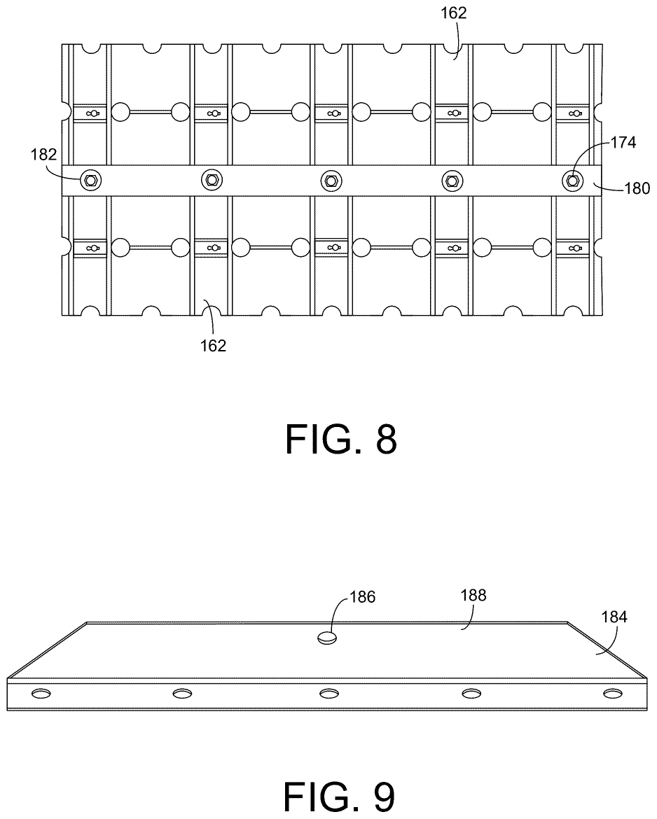

FIG. 8 is a top view of the top support 162. As can be seen, this configuration accommodates five top supports 162 and five bottom supports. Each of the top supports 162 is arranged in spaced relationship to each other. The cross member 180 will joined to the respective rods 174 extending through the respective top supports 162. A suitable washer and bolt assembly 182 is secured to the upper end of the rods 174 so as to affix the rods 174 to the cross member 180. FIG. 9 illustrates the configuration of the crossbar 184. Crossbar 184 includes a central lifting element 186 formed at the top surface 188 thereof. The crossbar 184 will be placed across the top support 162. The crossbar 184 provides a single-point-of-attachment for a hoist for the removal of the coalescing stack 160 from a vessel.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

We claim:

1. A coalescing system for separating immiscible components of different densities mixed in a fluid, the coalescing system comprising:
a vessel having a fluid inlet and a lighter component outlet and a heavier component outlet;
a coalescing stack formed of a first coalescing plate and a second coalescing plate arranged in spaced relation to each other, each of the first coalescing plate and the second coalescing pate having corrugations defining crests and valleys thereon; and
a plurality of pegs affixed to each of the first coalescing plate and the second coalescing plate, said plurality of pegs of the first coalescing plate engaging said plurality of pegs of the second coalescing plate in a first position so as to define a first distance between the first coalescing plate and the second coalescing plate, the first coalescing plate being movable with respect to the second coalescing plate to a second position such that an engagement between the plurality of pegs of the first coalescing plate and the plurality of pegs of the second coalescing plate defines a second distance between the first coalescing plate and the second coalescing plate, the first distance being different than the second distance.

2. The coalescing system of claim 1, wherein the plurality of pegs are positioned in at least some of the valleys of the first coalescing plate, the plurality of pegs being positioned in at least some of the valleys of the second coalescing plate.

3. The coalescing system of claim 2, wherein each peg of the plurality of pegs comprises:
a body having an outer surface and a pair of internal channels formed interior of said body.

4. The coalescing system of claim 3, wherein the outer surface of the peg of the second coalescing plate engages one of the pair of internal channels of the peg of the first coalescing plate in the first position.

5. The coalescing system of claim 4, wherein the outer surface of the peg of the second coalescing plate engages another of the pair of channels of the peg of the first coalescing plate in the second position.

6. The coalescing system of claim 5, wherein said body has a projection extending outwardly therefrom, the projection having at least one external shoulder formed thereon, wherein one of the pair of channels of said body has at least one internal shoulder formed therein.

7. The coalescing system of claim 6, wherein the external shoulder of the projections of the body of the plurality of pegs on the second coalescing plate is received in one of the pair of channels of the body of the plurality of pegs on the first coalescing plate so as to abut the internal shoulder of the internal channel when the first coalescing plate and the second coalescing plate are in the first position.

8. The coalescing system of claim 7, wherein the first distance between the first coalescing plate and the second coalescing plate is one-quarter inch.

9. The coalescing system of claim 6, wherein the projection of said body has a tip portion, the tip portion of the body of the peg of the plurality of pegs on the second coalescing plate is received in the another channel of the body of the plurality of pegs on the first coalescing plate so as to separate the first coalescing plate from the second coalescing plate by the second distance.

10. The coalescing system of claim 9, wherein the second distance is one-half inch.

11. The coalescing system of claim 1, wherein the first coalescing plate is rotated by 180° with respect to the second coalescing plate so as to move from the first position to the second position.

12. The coalescing system of claim 1, wherein each peg of the plurality of pegs is injection molded of a polymeric material.

13. The coalescing system of claim 3, wherein the pair of internal channels of the body of said body of each peg of said plurality of pegs is the in side-by-side parallel axial relationship.

14. The coalescing system of claim 3, wherein said body of each peg of said plurality of pegs has a curved outer surface conforming to a curvature of the corrugation of the coalescing plate of said coalescing stack.

15. The coalescing system of claim 14, wherein the coalescing plate has overlapping holes formed therein, the overlapping holes receiving the body of the peg of said plurality of pegs.

16. A peg article rejoining coalescing plates of a coalescing stack, the peg article comprising:
a body having a pair of channels formed therein; and
a projection extending outwardly of said body, said projection having at least one external shoulder formed thereon and a tip portion, the tip portion being distal said body, one of the pair of channels having an internal shoulder formed therein.

17. The peg article of claim 16, wherein the tip portion of said projection has a diameter less than an inner diameter of one of the pair of channels of said body.

18. The peg article of claim 16, wherein one of the pair of channels opens at a bottom of said body so as to define an opening, the opening having a diameter greater than the diameter of the external shoulder of the projection, the internal shoulder having a diameter less than a diameter of the external shoulder of said projection.

19. The peg article of claim 16, wherein the pair of channels of said body are in axially parallel relationship to each other.

20. The peg article of claim 16, wherein each of the coalescing plates of the coalescing stack has a corrugated surface, wherein said body has a curved outer surface conforming to the corrugated surface.
